(19) United States
(12) Patent Application Publication
(10) Pub. No.: US 2021/0074448 A1
(43) Pub. Date: Mar. 11, 2021

(54) Electrical cable comprising a filling compound

(71) Applicant: NEXANS, Courbevoie (FR)

(72) Inventors: Raphaël GUFFOND, LYON (FR); Gabriele PEREGO, Milan (IT); Andreas GABRIELSEN, NITTEDAL (NO); Romain ANNOOT, MESNIL EN OUCHE (FR)

(21) Appl. No.: 16/937,120

(22) Filed: Jul. 23, 2020

(30) Foreign Application Priority Data
Jul. 26, 2019 (FR) 19 08570

(51) Int. Cl. H01B 7/18; C08L 23/12; H01B 3/30

(52) U.S. Cl. CPC H01B 7/1895; C08K 2003/262; H01B 3/30; C08L 23/12

(57) ABSTRACT

An electrical cable (100, 101) includes at least one elongated electrical conductor (1), at least one protective element (4, 41, 42) surrounding the elongated electrical conductor (1), and at least one filling compound (5) surrounded by said protective element (4, 41, 42). The filling compound (5) has more than 20.0% by weight of a mineral oil, relative to the total weight of the filling compound, and at least one nanofiller.

### RELATED APPLICATION

This application claims the benefit of priority from French Patent Application No. FR 19 08570, filed on Jul. 26, 2019, the entirety of which is incorporated by reference.

### FIELD OF THE INVENTION

The present invention relates to an electrical cable comprising at least one elongated electrical conductor, at least one protective element surrounding said elongated electrical conductor, and at least one filling compound, and also to a process for producing said electrical cable.

The invention typically but non-exclusively applies to electrical cables intended for power transportation, in particular under a voltage of 1 kV to 40 kV, and preferably of approximately 3 kV with alternating current, and/or to telecommunication cables.

The preferred field of application of the invention relates to underwater electrical cables of umbilical type, such as for example remotely operated vehicle (ROV) cables.

### DESCRIPTION OF RELATED ART

In electrical cables for remotely operated vehicles, the gaps or voids formed between the insulated electrical conductors are conventionally filled with a hot-melt adhesive, intended to form a barrier to water.

However, this hot-melt adhesive induces ageing, in particular under thermal stress, of the electrical conductor insulator with which it is in contact, and as a result the electrical cable does not exhibit optimal electrical breakdown strength properties.

### OBJECTS AND SUMMARY

The objective of the present invention is to overcome the drawbacks of the prior art by providing in particular an electrical cable comprising a new filling compound which makes it possible to improve the breakdown strength of the electrical cable, and which has a viscosity which is stable regardless of the temperature of the electrical cable in operational configuration.

A subject of the present invention is an electrical cable comprising at least one elongated electrical conductor, at least one protective element surrounding said elongated electrical conductor, and at least one filling compound surrounded by said protective element, characterized in that the filling compound comprises:

more than 20.0% by weight of a mineral oil, relative to the total weight of the filling compound, and

at least one nanofiller.

By virtue of the invention, the electrical cable has a significantly improved breakdown strength (i.e. dielectric rigidity).

In addition, the viscosity of the filling compound is stable regardless of the temperature of the electrical cable in operational configuration. The viscosity is high regardless of the temperature of the electrical cable. More particularly, the filling compound placed inside the electrical cable according to the invention has a viscosity that is substantially constant regardless of the temperature variations of the cable during operation thereof. Thus, the flow of the filling compound in the cable is significantly limited, or even avoided, guaranteeing homogeneity of the filling compound throughout the length of the cable. Finally, the electrical cable has good moisture-barrier and/or water-barrier properties, in particular by virtue of the hydrophobic nature of the filling compound.

The Filling Compound

In the invention, the filling compound may comprise at least 30.0% by weight of mineral oil, preferably more than 50.0% by weight of mineral oil, and particularly preferably at least 60.0% by weight of mineral oil, relative to the total weight of the filling compound.

It may also comprise at most 95.0% by weight of mineral oil, and preferably at most 90% by weight of mineral oil, relative to the total weight of the filling compound.

The filling compound may comprise an amount of nanofiller necessary and sufficient to obtain a filling compound with the desired viscosity, and in particular to obtain a filling compound with a viscosity of at least 100 pascal second (Pa.$), preferably of at least 200 Pa·s, and particularly preferably of at least 300 Pa·s, determined at 100° C. according to standard ASTM D 4440.

The viscosity of the filling compound may be at most 1400 Pa·s, preferably at most 1000 Pa·s, preferably at most 700 Pa·s, and particularly preferably at most 500 Pa·s, determined at 40° C. according to standard ASTM D 4440.

By way of example, the filling compound may comprise at least 0.2% by weight of nanofiller, preferably at least 1.0% by weight of nanofiller, preferably at least 5.0% by weight of nanofiller, preferably at least 10% by weight of nanofiller, preferably at least 15% by weight of nanofiller, and particularly preferably at least 20% by weight of nanofiller, relative to the total weight of the filling compound.

It may also comprise less than 80.0% by weight of nanofiller, preferably at most 60.0% by weight of nanofiller, preferably less than 50.0% by weight of nanofiller, and particularly preferably at most 40.0% by weight of nanofiller, relative to the total weight of the filling compound.

Preferably, the filling compound may comprise from 60.0 to 90.0% by weight of mineral oil and from 10.0 to 40.0% by weight of nanofiller, relative to the total weight of the filling compound.

The filling compound may also comprise one or more additives. The additives are well known to those skilled in the art and can be chosen from antioxidants. The filling compound may typically comprise from 0.01 to 5% by weight, and preferably from 0.1 to 2% by weight of additives, relative to the total weight of the filling compound.

In one particularly preferred embodiment, the filling compound may only comprise one or more mineral oil(s) and one or more nanofiller(s).

The Mineral Oil

The chemical composition of a mineral oil is conventionally defined by its paraffinic carbon (Cp) content, its naphthenic carbon (Cn) content and its aromatic carbon (Ca) content. The mineral oils can also contain a low percentage of hydrocarbon molecules which comprise in their structure heteroatoms such as nitrogen, sulfur or oxygen (e.g. polar compounds).

The Cp, Cn and Ca contents can be easily determined according to standard ASTM D 2140.

According to one particularly preferred embodiment of the invention, the mineral oil may comprise a paraffinic carbon (Cp) content ranging from 45 to 65 atomic % approximately, a naphthenic carbon (Cn) content ranging from 35 to 55 atomic % approximately and an aromatic carbon (Ca) content ranging from 0.5 to 10 atomic % approximately.

The mineral oil may be liquid at approximately 20-25° C., and may in particular be obtained from the refining of a crude oil.

The mineral oil of the invention may be chosen from naphthenic oils, paraffinic oils, and a mixture thereof. Preferably, the mineral oil is a naphthenic oil.

The Nanofiller

The nanofiller of the invention is more particularly a filler of nanometric size.

At least one of the dimensions of the nanofiller(s) of the invention is of nanometric size (10⁻⁹ metre).

In the present invention, the term “nanofiller” is intended to mean an elementary particle. A collection of elementary particles may be an agglomerate or aggregate of elementary particles, depending on the dimensions.

More particularly, at least one of the dimensions of the nanofiller(s) of the invention (i.e. one or more elementary particles) may be at most 2000 nm (nanometres), preferably at most 1000 nm, preferably at most 800 nm, preferably at most 600 nm, preferably at most 400 nm, and more preferentially at most 100 nm.

In addition, at least one of the dimensions of the nanofiller(s) of the invention may be at least 1 nm, and preferably at least 5 nm.

Preferably, at least one of the dimensions of the nanofiller(s) of the invention may range from 1 to 800 nm.

When considering several nanofillers according to the invention, the term “dimension” is intended to mean the number-average dimension of all the nanofillers of a given population, this dimension conventionally being determined by methods well known to those skilled in the art.

The size of the nanofiller(s) according to the invention can be for example determined by microscopy, in particular by scanning electron microscopy (MEB) or by transmission electron microscopy (MET). More particularly, the size of the nanofiller(s) can be determined by MET on at least about twenty images, by preparation of samples of the filling compound type comprising said nanofiller(s), at approximately −140° C. with thicknesses of approximately 100 nm, the samples then being positioned on a copper support for the observation by MET. This preparation technique is referred to as cryo-ultramicrotomy.

At least one of the nanofillers, or more particularly the nanofillers included in the filling compound, can have:

an aspect ratio substantially equal to 1: the term “isodimensional nanofiller” is then used, or

an aspect ratio greater than 1, preferably of at least 10, and preferably of at least 100.

In the present invention, the aspect ratio is typically the ratio between the largest dimension of a nanofiller (such as for example the length of a nanofiller when it is of the lamellar or cylindrical type) and the smallest dimension of the nanofiller (such as for example the thickness of a nanofiller of the lamellar type, or the diameter of a nanofiller of the cylindrical type). The nanofiller of the invention may preferably be an inorganic nanofiller which can be chosen from alkaline-earth metal carbonates, alkaline-earth metal sulfates, metal oxides, metalloid oxides, metal silicates, and siloxanes (or organosilicon three-dimensional oligomers).

By way of example:

the alkaline-earth metal carbonate nanofillers may be calcium carbonate nanofillers,

the alkaline-earth metal sulfate nanofillers may be barium sulfate nanofillers,

the metal oxide nanofillers, or in other words nanofillers comprising only one or more oxygen elements and one or more metal elements, may be nanofillers of alumina (Al₂O₃), of zinc oxide (ZnO), of titanium dioxide (TiO₂), of magnesium oxide (MgO), of iron oxides (Fe₂O₃, Fe₃O₄),

the metalloid oxide nanofillers may be silicon dioxide (silica) nanofillers, in particular fumed silica nanofillers,

the metal silicate nanofillers may be for example aluminosilicates (nano-clay), or nanofillers of magnesium aluminium silicate hydrate, such as montmorillonite belonging to the phyllosilicate family,

the nanofillers of siloxanes or of organosilicon three-dimensional oligomers may be nanofillers of silsesquioxanes (POSS) or derivatives thereof, such as for example trisilanolphenyl polyhedral silsesquioxane (TP-POSS) nanofillers.

Preferably, the nanofillers of the invention may be metal oxide nanofillers and/or metalloid oxide nanofillers.

The nanofiller of the invention may be a filler termed “treated” or a filler termed “non-treated”.

The term “treated filler” is intended to mean a filler which has undergone a surface treatment, or, in other words, a surface-treated filler. Said surface treatment makes it possible in particular to modify the surface properties of the filler, for example in order to improve the compatibility of the nanofiller with the mineral oil.

In one preferred embodiment, the nanofiller of the invention may be a silanized filler, or in other words a nanofiller that has been treated in order to obtain a silanized nanofiller.

The surface treatment used to obtain a silanized nanofiller is in particular a surface treatment using at least one silane compound (with or without coupling agent), this type of surface treatment being well known to those skilled in the art.

Thus, the silanized nanofiller of the invention may comprise siloxane and/or silane groups at its surface. Said groups may be of the vinylsilane, alkylsilane, epoxysilane, methacryloxysilane, acryloxysilane, aminosilane or mercaptosilane type.

The silane compound used to obtain the silanized nanoparticle may be preferably chosen from:

alkyltrimethoxysilanes or alkyltriethoxysilanes, such as for example octadecyltrimethoxysilane (OdTMS—C18), octyl(triethoxy)silane (OTES—C8), methyltrimethoxysilane, hexadecyltrimethoxysilane,

vinyltrimethoxysilanes or vinyltriethoxysilanes,

methacryloxysilanes or acryloxysilanes, such as for example 3-methacryloxy-propylmethyldimethoxysilane, 3-methacryloxypropyltrimethoxysilane, 3-acryloxypropyltrimethoxysilane,

chlorosilanes, such as for example dimethyl dichlorosilane, and

a mixture thereof.

The treated nanofiller or the non-treated nanofiller according to the invention may preferably have a specific surface area (BET) of at least 70 m²/g, preferably of at least 100 m²/g, and preferably of at least 120 m²/g. The nanofiller may have a specific surface area (BET) of at most 1000 m²/g, and preferably of at most 500 m²/g.

In the present invention, the specific surface area of a treated nanofiller or of a non-treated nanofiller can be easily determined according to standard DIN 9277 (2010).

The Electrical Cable

The electrical cable of the invention comprises one or more elongated electrical conductor(s), at least one protective element surrounding said elongated electrical conductor(s), and at least one filling compound as defined in the present description, the filling compound being surrounded by said protective element.

The elongated electrical conductor may be a monoconductor, such as for example a metal wire, or a multiconductor, such as a plurality of metal wires, which may or may not be twisted together. The elongated electrical conductor may be made from a metallic material in particular chosen from aluminium, an aluminium alloy, copper, a copper alloy, and a combination thereof.

The protective element may be chosen from one or more polymeric layer(s), one or more metallic layer(s), and a combination thereof.

In the present invention, the term “polymeric layer” is intended to mean a layer comprising at least one polymer, it being possible for the polymeric layer to be advantageously extruded. The polymer of the polymeric layer may be that described in the remainder of the description.

The term “metallic layer” is intended to mean a layer comprising at least one metal or one metal alloy.

The filling compound may be positioned between at least two elongated electrical conductors, and/or between at least one elongated electrical conductor and the protective element.

In one particular embodiment, the electrical cable may also comprise an insulating element, in particular an electrically insulating element, surrounded by the protective element.

The insulating element may surround at least said elongated electrical conductor. This may then be referred to as an insulating layer. The assembly comprising said elongated electrical conductor surrounded by said insulating layer can form an insulated electrical conductor.

The filling compound may be in direct physical contact with the insulating element. More particularly, when the electrical cable comprises at least one insulated electrical conductor, the filling compound may be in direct physical contact with said insulated electrical conductor.

Said insulating element may advantageously comprise at least one polymer, and may preferably be an element extruded by techniques well known to those skilled in the art.

More particularly, the insulating element may comprise at least 20.0% by weight of polymer, preferably more than 50.0% by weight of polymer, and particularly preferably at least 70.0% by weight of polymer, relative to the total weight of the insulating element.

In the present invention, the term “polymer” is intended to mean any type of polymer well known to those skilled in the art, such as homopolymers or copolymers (e.g. block copolymer, random copolymer, terpolymer, etc.).

The polymer may advantageously be an olefin polymer (polyolefin) or, in other words, an olefin homopolymer or copolymer. Preferably, the olefin polymer is an ethylene polymer or a propylene polymer.

In one preferred embodiment, the polymer may be a non-polar polymer, and preferably a non-polar olefin polymer.

The non-polar polymer thus substantially does not comprise any polar groups such as, for example, acrylate, carboxylic or vinyl acetate groups.

By way of example, the polymer may be chosen from a linear low-density polyethylene (LLDPE), a low-density polyethylene (LDPE), a medium-density polyethylene (MDPE), a high-density polyethylene (HDPE), an ethylene copolymer, a propylene copolymer, and a mixture thereof.

In one particular embodiment, the insulating element may conventionally be a thermoplastic or non-crosslinked layer.

The electrical cable of the invention may be an electrical cable intended for power transportation and/or a telecommunication cable, such as for example a remotely operated vehicle cable.

Preferably, the electrical cable of the invention may comprise:

a. several insulated electrical conductors, and optionally one or more non-insulated electrical conductors,

b. at least one filling compound as defined in the invention, and

c. a protective element surrounding the assembly of insulated electrical conductors and said filling compound.

The insulated electrical conductors (a) can be arranged in the electrical cable in the following way. The electrical cable can comprise a first assembly comprising one or more insulated electrical conductors, this first assembly being surrounded by a separation layer, and a second assembly comprising one or more insulated electrical conductors, this second assembly being positioned around said first assembly.

The non-insulated electrical conductor(s) can be positioned in the first assembly and/or in the second assembly. These non-insulated electrical conductors are well known to those skilled in the art under the name screen wire or grounding conductor.

The separation layer between the first and the second assembly may comprise at least one polymeric layer and/or one metallic layer, the polymeric layer and the metallic layer being in particular described in the present invention.

The metallic layer of the separation layer may be in particular a metallic grounding screen, such as for example a metal strip. The metallic layer of the separation layer may advantageously be used to ground the first assembly of insulated electrical conductors.

The filling compound (b) may be positioned in the first assembly and/or in the second assembly and/or between the first and the second assembly. More particularly, the filling compound may be positioned between the insulated electrical conductors of the first assembly and/or between the insulated electrical conductors of the second assembly and/or between the insulated electrical conductors of the first and of the second assemblies.

The protective element (c), surrounding the assembly of the insulated electrical conductors and said filling compound, may be chosen from one or more polymeric layer(s), one or more metallic layer(s), and a combination thereof.

The polymeric layer of the protective element may be in the form of an extruded layer and/or of a wound layer. By way of example, it may be a polyester layer and/or a polyurethane layer.

The metallic layer of the protective element may be in the form of an assembly of twisted or non-twisted metallic conductors, of a metal strip and/or of a metal tube. By way of example, it may be a copper layer, a copper alloy layer and/or a steel layer.

The metallic layer of the protective element may advantageously be used to ground the second assembly of insulated electrical conductors.

In one particular embodiment, the protective element (c) comprises at least a first polymeric layer surrounded by a first metallic layer. It may also comprise a second metallic layer surrounded by the first polymeric layer and a second polymeric layer surrounding the first metallic layer.

Process for Producing an Electrical Cable

Another subject of the invention is a process for producing an electrical cable according to the invention, comprising the step of applying the filling compound in the electrical cable of the invention, by pressure, in particular inside the zone delimited by the protective element, the application being carried out via at least one end of the electrical cable.

Preferably, the filling compound is injected into the gaps or voids that are between the elongated electrical conductors, and in particular between the insulated electrical conductors. This may then be referred to as pressurized filling injection.

This injection can be carried out by means of a pump placed at one end of the electrical cable. By way of example, the pressure used to inject the filling compound can range from 10 bar to 100 bar, and preferably from 10 bar to 60 bar.

Other features and advantages of the present invention will emerge in the light of the description of non-limiting examples of filling compounds and of cables according to the invention, given in particular with reference to the following figures.

### BRIEF DESCRIPTION OF THE DRAWINGS

FIG. 1 represents a schematic view of an electrical cable according to a first particular embodiment in accordance with the invention.

FIG. 2 represents a schematic view of an electrical cable according to a second particular embodiment in accordance with the invention.

### DETAILED DESCRIPTION

For reasons of clarity, only the elements essential for understanding the invention have been represented schematically, without being to scale.

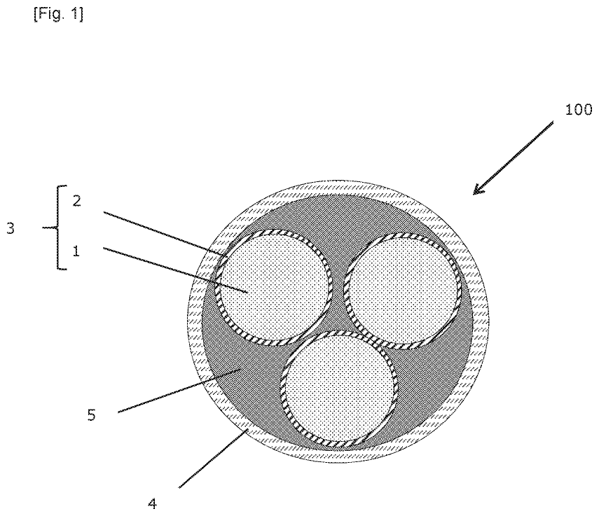

FIG. 1 represents an electrical cable 100 according to a first particular embodiment of the invention.

The electrical cable 100 comprises several elongated electrical conductors 1, each of said elongated electrical conductors 1 being surrounded by at least one electrically insulating layer 2, thus forming insulated electrical conductors 3.

The assembly of the insulated electrical conductors 3 is surrounded by a protective element 4 of the extruded polymeric layer type.

A filling compound 5 according to the invention is positioned inside the zone delimited by the protective element 4, and in particular in the gaps or voids between the various insulated electrical conductors 3. The protective element 4 therefore surrounds the filling compound 5.

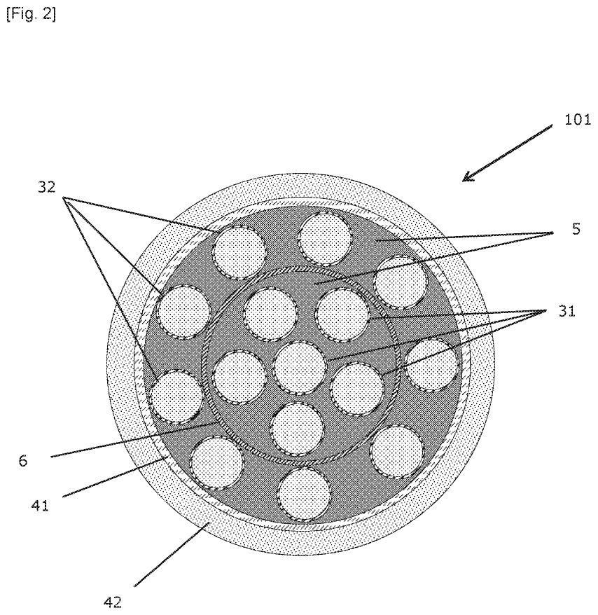

FIG. 2 represents an electrical cable 101 according to a second particular embodiment of the invention.

The electrical cable 101 is in particular a remotely operated vehicle cable, and comprises a first assembly 31 of insulated electrical conductors 3, this first assembly 31 being surrounded by a separation layer 6. The separation layer 6 comprises a polymeric layer of a propylene polymer, surrounded by a metallic layer of the wound copper layer type. The metallic layer of the separation layer 6 is a metallic screen used to ground the first assembly 31.

The electrical cable also comprises a second assembly 32 of insulated electrical conductors 3, this second assembly 32 being positioned around said first assembly 31.

The electrical cable also comprises a protective element, said protective element surrounding the first assembly 31 of insulated electrical conductors, the second assembly 32 of insulated electrical conductors, and the separation layer 6.

The protective element comprises a first polymeric layer 41 of the polyester thermoplastic layer type, surrounded by a first metallic layer 42 comprising a plurality of steel conductors, preferably helically twisted together.

The protective element may also comprise a second metallic layer (not represented) of the wound copper layer type, surrounded by the first polymeric layer 41. Said second metallic layer of the protective layer is a metallic screen used to ground the second assembly 32.

The protective element may also comprise a second polymeric layer (not represented) of the wound polyurethane layer type, surrounding the first metallic layer 42.

The electrical cable may also comprise non-insulated electrical conductors (not represented), termed grounding conductors, positioned in the first assembly and in the second assembly.

A filling compound 5 according to the invention is positioned inside the zone delimited by the protective element, and in particular in the gaps or voids between the various insulated and non-insulated electrical conductors of the first assembly 31 and of the second assembly 32. The protective element, composed at least of the layers 41 and 42, thus surrounds the filling compound 5.

### Examples

1. Preparation of a Filling Compound According to the Invention

A filling compound (I1) in accordance with the invention is prepared with the following constituents:

73% by weight of mineral oil, and

27% by weight of nanofiller,

the percentages (%) by weight being expressed relative to the total weight of the filling compound.

The origin of the constituents described in the example above is the following:

the mineral oil is a mineral oil of naphthenic type sold by the company Nynas under the reference Nyflex 820, the oil comprising 7% of aromatic carbon atoms, 40% of naphthenic carbon atoms and 53% of paraffinic carbon atoms; and

the nanofiller is silicon oxide particles surface-treated with dimethyl dichlorosilane (DDS), sold by the company Aerosil under the reference Aerosil R 974, this nanofiller having the following characteristics: spherical elementary particles with an aspect ratio substantially equal to 1, the diameter of which is less than 100 nm, and the specific surface area (BET) of which is 170±20 m²/g.

The filling compound I1 is prepared by mixing the nanofiller with the mineral oil, in a mixer, at ambient temperature (25° C.), for approximately 5 minutes at a speed of approximately 2200 revolutions per minute.

2. Characterizations

In order to study the viscosity of the filling compound of the invention, tests are prepared with the compound I1, and with a comparative filling compound (C1) of the hot-melt adhesive type. The hot-melt adhesive used is that sold by the company Henkel under the reference Technomelt PS 8673L.

In this respect, discs of compounds I1 and C1, with a radius of 25 mm and a thickness of approximately 2 mm, are formed using a mould.

The viscosity of the compounds I1 and C1 is determined according to standard ASTM D 4440 using a dynamic viscometer in plate-plate configuration under a frequency of 50 Hz, with a deformation of 5% and a temperature gradient of 5° C./min.

The viscosity results in pascal second (Pa·s) are collated in Table 1 below, as a function of the temperature in ° C.

TABLE 1

| | 40° C. | 50° C. | 60° C. | 70° C. | 80° C. | 90° C. | 100° C. |
|---|---|---|---|---|---|---|---|
| I1 | 423 | 415 | 397 | 372 | 338 | 316 | 326 |
| C1 | 770 | 498 | 417 | 394 | 377 | 337 | 294 |

In order to study the breakdown strength of an insulating layer in contact with the filling compound, the following tests are prepared:

Test 1 (test according to the invention): an insulating layer in contact with the compound I1,

Test 2 (comparative test): an insulating layer in contact with the compound C1, and

Test 3 (comparative test): an insulating layer alone, the insulating layer being a layer of a propylene copolymer sold by Borealis under the reference PP4821.

In this respect, about ten sheets of the insulating layer alone (i.e. layer of a propylene copolymer according to Test 3), 75 mm in diameter and 500 μm thick, are formed for each test (in order to verify the repeatability of the results regarding the breakdown measurements).

For Test 1, 10 grams of compound I1 are deposited on each face of the insulating layer of Test 3.

For Test 2, 10 grams of compound C1 are deposited on each face of the insulating layer of Test 3.

Thus, Tests 1 and 2 comprise a trilayer (i.e. the insulating layer of Test 3 sandwiched between two layers of the compound I1 or C1). The trilayers of Test 1 and of Test 2 are placed in an oven under 100° C. for 10 days.

The two layers of compound I1 and the two layers of compound C1 are then removed from the trilayers in question, after the 10 days. The breakdown strength is then measured on the residual insulating layer of Test 1 and on the residual insulating layer of Test 2.

With regard to Test 3, the sheet of insulating layer alone, which does not comprise compound I1 or C1, is not placed in the oven, and the breakdown strength is directly measured on about ten of these sheets.

The breakdown (dielectric) strength of Tests 1 to 3 is determined according to standard ASTM D 149 by means of an alternating current breakdown bench.

The results are collated in Table 2 below.

TABLE 2

| | Test 1 | Test 2 | Test 3 |
|---|---|---|---|
| Alternating current dielectric breakdown | 98 | 78 | 89 |
| strength (expressed in kV/mm) at 25° C. | | | |

1. Electrical cable comprising:
at least one elongated electrical conductor,
at least one protective element surrounding said elongated electrical conductor, and
at least one filling compound surrounded by said protective element,
wherein the filling compound comprises:
more than 20.0% by weight of a mineral oil, relative to the total weight of the filling compound, and
at least one nanofiller.

2. Cable according to claim 1, wherein the filling compound comprises more than 50.0% by weight of mineral oil, and preferably at least 60.0% by weight of mineral oil, relative to the total weight of the filling compound.

3. Cable according to claim 1, wherein the filling compound comprises less than 50.0% by weight of nanofiller, and preferably at most 40.0% by weight of nanofiller, relative to the total weight of the filling compound.

4. Cable according to claim 1, wherein the viscosity of the filling compound is at least 100 Pa·s, determined at 100° C. according to standard ASTM D 4440.

5. Cable according to claim 1, wherein the mineral oil is chosen from naphthenic oils, paraffinic oils, and mixtures thereof.

6. Cable according to claim 1, wherein at least one of the dimensions of the nanofiller is at most 2000 nm, and preferably at most 1000 nm.

7. Cable according to claim 1, wherein the nanofiller is a treated filler.

8. Cable according to claim 1, wherein the nanofiller is a silanized filler.

9. Cable according to claim 1, wherein the nanofiller has a specific surface area (BET) of at least 70 m²/g, and preferably of at least 100 m²/g.

10. Cable according to claim 1, wherein the nanofiller is a mineral filler, preferably chosen from alkaline-earth metal carbonates, alkaline-earth metal sulfates, metal oxides, metalloid oxides, metal silicates, and siloxanes.

11. Cable according to claim 1, wherein said cable also comprises an insulating element (2) surrounded by the protective element.

12. Cable according to claim 11, wherein the insulating element comprises at least one propylene polymer.

13. Cable according to claim 11, wherein the filling compound is in direct physical contact with the insulating element.

14. Cable according to claim 1, wherein the protective element is chosen from a polymeric layer, a metallic layer, and a combination thereof.

15. Cable according to claim 1, wherein the cable is a remotely operated submersible vehicle cable.
